(19) United States
(12) Patent Application Publication
(10) Pub. No.: US 2014/0129266 A1
(43) Pub. Date: May 8, 2014

(54) SOCIAL INTERACTIVE TICKETING SYSTEM

(71) Applicant: UTIX SOCIAL TICKETING, LLC, New York, NY (US)

(72) Inventors: Harrison PERL, New York, NY (US); Jonathan KLEINMAN, Houston, TX (US)

(73) Assignee: UTIX SOCIAL TICKETING, LLC, New York, NY (US)

(21) Appl. No.: 14/071,690

(22) Filed: Nov. 5, 2013

Related U.S. Application Data
(60) Provisional application No. 61/723,023, filed on Nov. 6, 2012.

(51) Int. Cl. G06Q 10/02; G06Q 50/00

(52) U.S. Cl. CPC G06Q 10/02; G06Q 50/01
USPC 705/5

(57) ABSTRACT

A cloud-based service is provided for sharing information about an event and obtaining tickets for the event by a user. The server is associated with a social network to identify friends of the user on said network. A user is provided information about an event together with information on whether any friends from the social network are attending the event. The user can select to attend the event on his own, or to attend the event and get tickets near his friends. Conversely, a user can buy or block a number of tickets for the event and then share the tickets with his friends.

### RELATED APPLICATIONS

This application claims priority to U.S. Provisional Application Ser. No. 61/723,023 filed on Nov. 6, 2012 and incorporated herein in its entirety.

### BACKGROUND OF THE INVENTION

A. Field of Invention

This invention pertains to a system for obtaining tickets for an event for several friends on a social network.

B. Description of the Prior Art

One of the favorite pastime of many people is to attend various public performances, including sporting events, musical or theatrical performances, art exhibits, etc. While often people want to share a performance by attending it with two or more other people, presently accomplishing this has become a major feat, mostly because each person has his or her own set of activities, priorities, preferences, work schedule, etc. While there are many electronic platforms presently in use, such as Twitter, Facebook, etc., they can be used by people to start coordinating a shared activity, such as the one just described, but could not be used to actually complete all the arrangements.

Thus there is a need for a system that can be integrated into existing platforms (or possibly used on its own) to allow people to coordinate attending a performance together, including the act of obtaining tickets.

### SUMMARY OF THE INVENTION

Briefly, in accordance with this invention, a cloud-based service is provided for sharing information about an event and obtaining tickets for the event by a user. The server is associated with a social network to identify friends of the user on said network. A user is provided information about an event together with information on whether any friends from the social network are attending the event. The user can select to attend the event on his own, or to attend the event and get tickets near his friends. Conversely, a user can buy or block a number of tickets for the event and then share the tickets with his friends.

Data on what events are liked by users, and, optionally, which users are proficient in sharing tickets with friends is collected by the server. The information is used to provide ads to the server participants, and/or provide promotional material and discounts to the participants.

### DESCRIPTION OF THE DRAWINGS

FIG. 1A shows a block diagram of a system implementing the present invention;

FIG. 1 shows a flow chart for establishing accounts for users on the system of FIG. 1A; and

FIG. 2 shows a general flow chart for selling tickets to users using the system of FIG. 1A.

FIGS. 3A and 3B show illustrative presentations to a user for an event without and with other friends expressing an interest, respectively;

FIG. 4A shows a flow chart for reserving a block of seats for friends; and

FIG. 4B shows a flow chart for buying a seat from the block of reserved seats; and

FIG. 4C shows a flow chart for seating a group of friends together.

### DETAILED DESCRIPTION OF THE INVENTION

The present invention provides a system for providing tickets for various performances wherein users can chose to go to the performance attended by some of their friends and can even provide them seats adjacent to or near their friends.

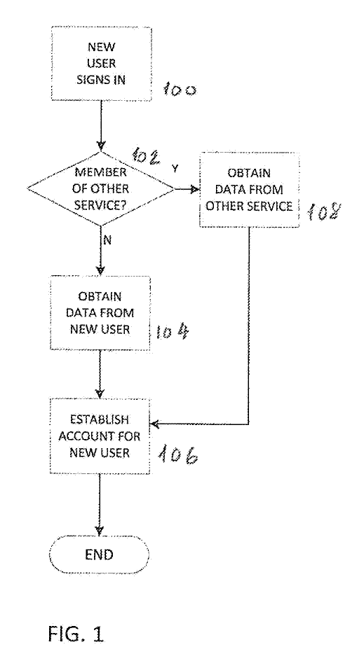

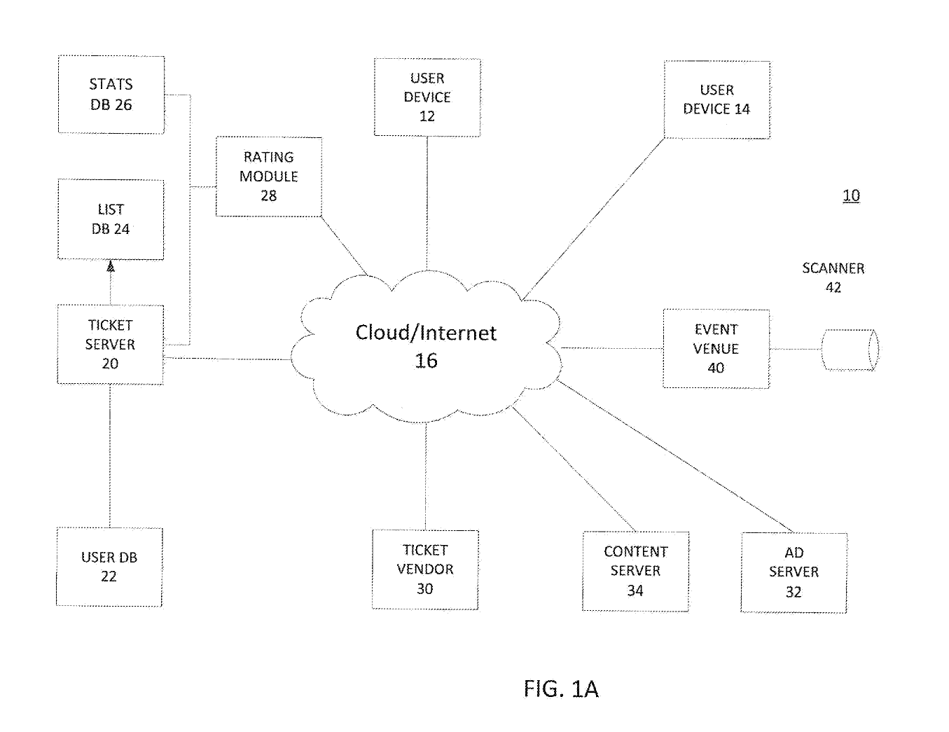

A preferred arrangement for the system 10 is shown in FIG. 1A. In this system, a user owns or is associated a first device 12 and a second user device 14. The first device 12 may be a desk top, laptop or tablet computer that is generally used at home. The second device 14 may be a smart phone, a tablet or other computer-based device that is generally worn by user and operated outside the home. Alternatively, the user is associated with a single device or more than two devices.

A respective application is provided in each user device that enabled the user to participate in the activities and take advantage of the functions provided. These activities and functions are generated or monitored by a ticket server 20. The server 20 is connected to or associated with a user database 22 and a list database 24. The server 20 may also collect information from various transactions with various users and use this information to build a statistics database 26.

An important feature of the invention is that it provides a means of obtaining tickets for various events. These tickets are obtained from a ticket vendor 30. It should be understood that the vendor 30 may be a dedicated vendor adapted to provide tickets for a particular venue and or event. In other words, a separate vendor similar vendor 30, provide for each venue and/or event. Alternatively, vendor 30 may be an aggregator selling tickets for all events.

Once a user buys a ticket, he can attend an event at an event venue 40 and he can present the ticket at the venue. The ticket may be either a paper ticket or an electronic ticket that has been downloaded into device 14. A scanner 42 at venue 40 is used to scan the user's ticket.

An important feature of the invention is that the user can share details about an event, whether he is or attending (or wants to attend an event), where he is seating, etc., with his friends from a social network 44 such as Facebook, Twitter, etc.

While attending the event, the user may be provided on his device (typically, device 14) with various external content preferably associated with the event. For example, if the event is a sporting event, the user may be provided with information on the teams playing, statistics associated with the team, each player of the team, etc. This content originates from a content server 34. Similarly, ads may be provided to the user on his device. These ads originate from an ad server 32.

The system can be setup as a separate website accessed by each user on his device(s), or, as mentioned above, as an application that can be run from the user devices 12, 14. It is preferable that accounts be set up for each user. A sign up process is shown in FIG. 1. When a new user accesses the system (step 100), first he is asked if he is a member the service or other associated services and he would like to use the information already available from these other services (step 102). If he is not a member of other services, or does not want to share the information from the other services, necessary data is obtained directly from the new user (step 104) and an account is established (step 106). Otherwise the account is established using data from the services designated by the user (e.g., Facebook, Paypal, etc.) (step 108). The data is stored in the user database 22 and this stage of the process ends (step 110).

An important feature of the present invention is that it provides a means for a person to book tickets to events that are being attended by other friends. Therefore, preferably, when a person signs up to the service, he is also given the opportunity to designate various friends with whom he wants to experience events. In one embodiment, the person designates a group of friends(identified, e.g., by email addresses or as members of the various social networks associated with the present service). In another embodiment, different friends may be designated for different events or types of events. For example, a person may decide to go to one type of events(e.g., sports) with a first group of friends; a second type of events (e.g., action movies) with a second group of friends, and so on. In one embodiment, a person may be designated by at least one of these groups of friends to buy tickets for all the members. All this information is stored into the database 22 with appropriate tags.

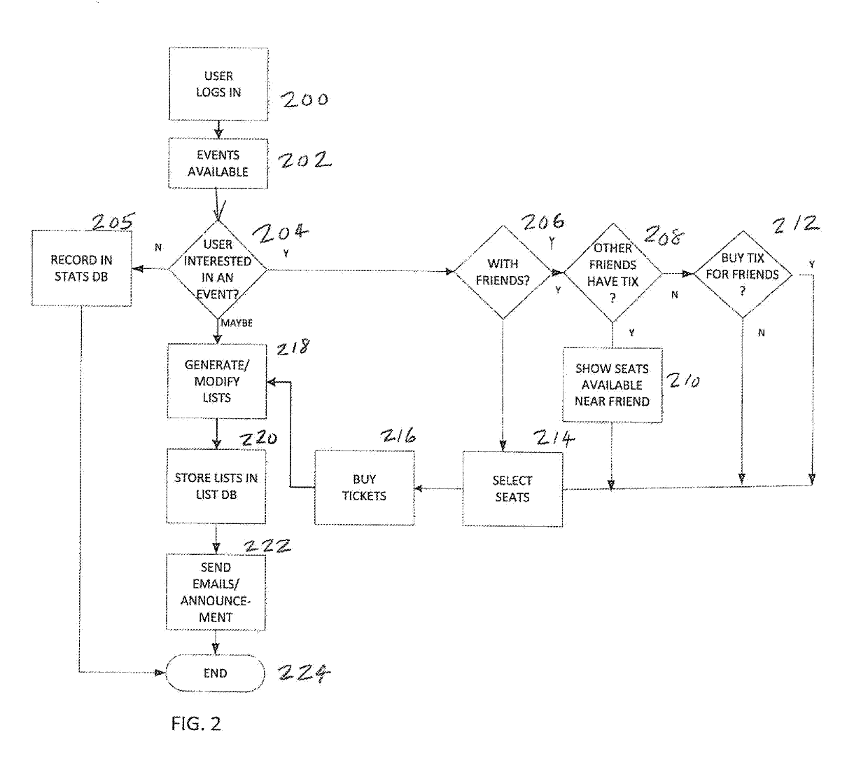

FIG. 2 shows how the system is used to obtain tickets. The user logs in to service (step 200) and is presented with events for which tickets are available from the service (step 202). The events can be organized using various criteria, as preferred by the user and/or the system administrator, including available dates, venues, and any friends that are either attending them or have expressed an interest in attending them. The user then has a choice of indicating that he is interested in attending an event optionally together with particular friends or groups of friends that he wants to be with.

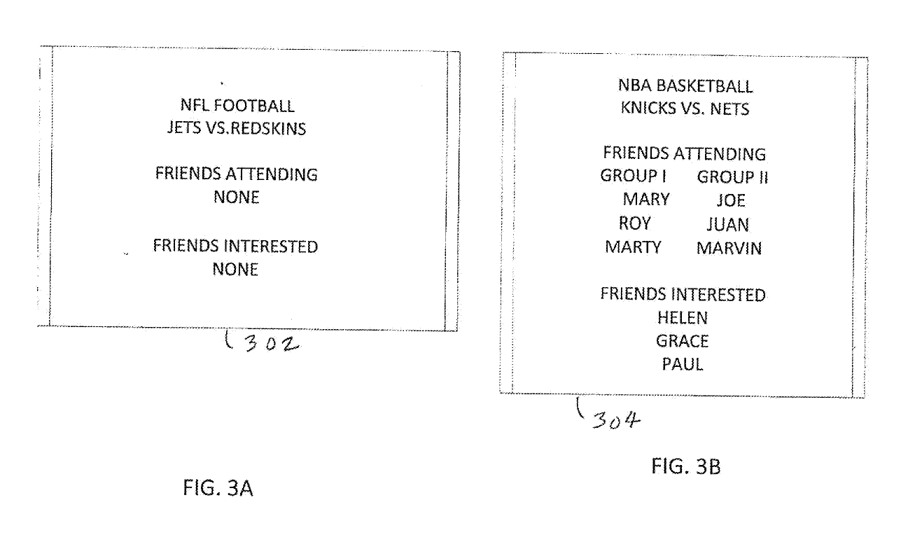

For example, a typical display 302 is shown in FIG. 3A showing that a tickets are available for an event, in this a football game. The display 302 further indicates that none of the user's friends have bought tickets to this event and none of this friends has shown any interest in this event. In another instance, the user is presented with an event (in this case, a basketball game), as shown in FIG. 3B. This time, three lists are also presented indicating to the user that a first group and a second group of friends are attending this event.

In step 204 the user indicates whether he wants to go to the event, is interested but not ready to buy a ticket, or is interested. (for example, by clicking on a button, or by other conventional means, not shown). Next (step 206) the user can indicate whether he wants to go to the event with friends from his social network or not. In one embodiment, once the user indicates that he wants to buy tickets near his friends, he is given the choice of having the server select what are the available seats near the user's friends. The server 20 analyzes the positions of available seats (and, possibly, their prices), and based on available information, selects the best possible seats near the friends. If two or more sets of friends are attending, the user is given the choice of selecting one of the groups. After the seats are bought, lists in the database 24 are updated automatically as well, and, optionally all the friends receive a notification that the user will be attending (and, optionally, that he bought the tickets for anybody else).

If he wants to go with friends, a determination is made from the list data base 24 whether any of the friends have already tickets (step 208). If they have tickets, their seats are shown together with any available seats near the friends (step 210). If the friends do not have tickets, the user is asked if he wants to buy the tickets for some friends or just buy tickets that then can be claimed by friends (step 212). In step 214 the user selects his seats. The number of seats depends on his answers in steps 206, 208, 212.

In step 216, a buying stage is initiated. In this stage, the ticket server 20 contacts the ticket vendor 30 and obtains the necessary tickets. The tickets are paid for (using, for example, a credit card listed or associated with the user in his profile). As indicated above, the user may decide to buy a single ticket or several tickets. Moreover, independently of whether any social friends are interested or not, a user can always by tickets for himself and his close friends.

Back in step 204, one of the choices for the user is ‘No’ in which case, the a record is made in the statistics database 26 indicating that the user may not be interested in this event (STEP 205). Alternatively, in step 204 the user may select ‘Maybe’ indicating that he may be interested in the event but is not ready to buy until he sees who else is going. In step 218 lists are generated indicating or updated indicating the decisions made in the previous steps. In step 220 the lists are stored in the list database 24 and information is entered in the statistics database 26.

In step 222, mails are sent to the social friends indicating that the user is going to the event, the seat(s) that he is using, the number of tickets, he bought appropriate lists in database 24 are updated to indicate that the respective user has bought one or more tickets. Then the next time a friend of the user signs on to the service and looks at the same event, he receives an indication that this particular user is attending the event.

Optionally, in step 222 an automatic announcement is sent either to all the designated friends, or all the friends in a certain group indicating that the user has bought tickets for the particular event. The announcement may also be posted on a social networks, or alternatively the lists can be automatically published by server 22 on an electronic boards, websites, etc.

As previously discussed, the user, when he signs up, or at any time, can designate the friends, or group of friends that for any or all events. For example, the user may designate one set of friends to go to football game, another set of events to go to the opera, etc. Preferably, when the user sets up groups of friends, only the friends within a group could see that the user is interested or has bought tickets for an event.

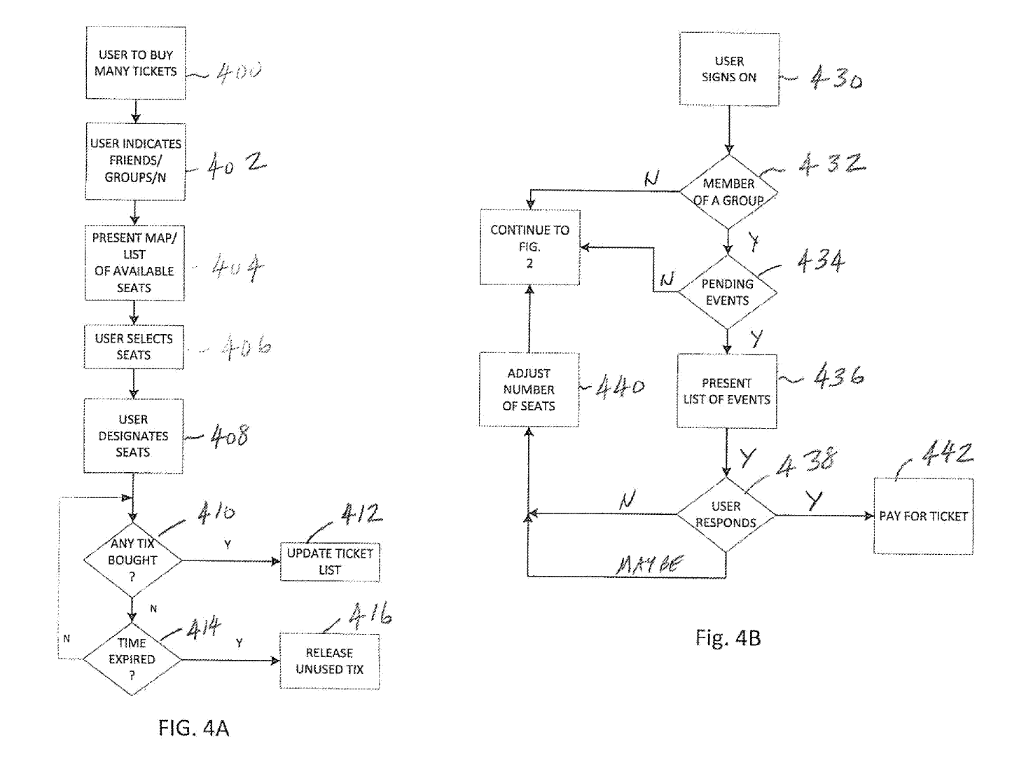

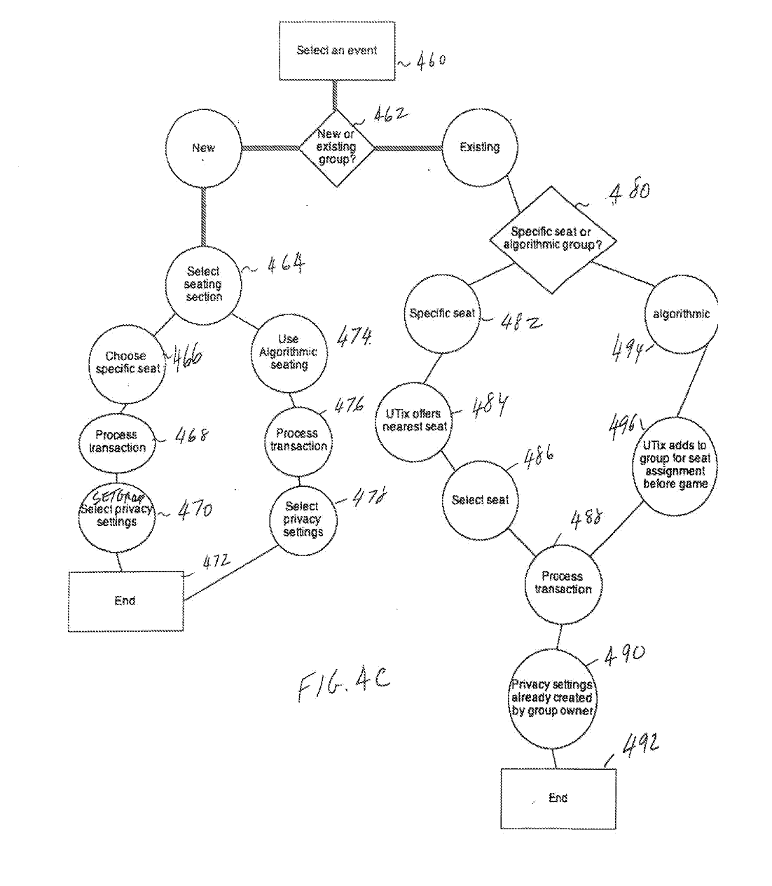

As mentioned above, in one embodiment, the service allows the user to set up or reserve a block of several seats for his group and the members of the group can then buy tickets within the block. Details of this process are shown in FIG. 4A. The user may select an event for which he wants to reserve a block of tickets (step 400). Next, he can designate which friends are eligible to use the reserved seats. For example, if his friends are arranged in groups A, B and C, he can select one or all of these groups, or he can select the friends by name (step 402). Alternatively, if a number of friends indicated that they were interested in the selected show, the user can designate these latter friends.

Alternatively, the user may choose a number of seats N to be reserved. Next, in step 404, the user can optionally be presented with a list or map showing all the available seats and the user then selects the seats to be reserved (step 406). Preferably, once a block has been set up, the members of the group are notified (step 408) and each member will have a predetermined time in which to respond and either buy one or more tickets or decline to attend the event. At regular interviews, the service checks whether any tickets of the reserved block have been bought (step 410) and the ticket list or count is adjusted accordingly (step 412). A check is also performed to determine if a predetermined amount of time has passed (step 414). Once this time has expired, the unused tickets are released to other customers (step 416).

Similarly, in this embodiment, when the user signs on (FIG. 4B step 430), a check is performed if he is a member of any group listed on database 24 (step 432). If he is not, the process outlined in FIG. 2 is followed. If he is a member of the group, a check is performed to determine if there are any pending events for which the user is eligible to buy a ticket from the block of reserved seats (step 434). If he is eligible, then the user is presented with a list of events, the respective group of friends (optionally with an indication of who bought seats and which seat did they buy) and the deadline for buying seats. In step 436, the user has three choices. He can decline, in which case, the inventory of reserved seats is adjusted (step 440) and the user can proceed as indicated in FIG. 2. He can accept, in which case, he is presented with a payment process to pay for his ticket (step 442). As part of the purchasing process, once a user selects to buy tickets, he can provide payment information, if not already provided as part of his profile.

After the ticket is paid for, the inventory is adjusted (step 440).

The user can elect to hold off the decision (indicated by “MAYBE”), in which case, no changes are made in the inventory.

Once tickets have been purchased, the ticket(s) can be sent electronically to a smart phone, in form of a unique bar code or QR code that is scanned at the venue when the user enters.

During the event, users can enjoy additional features through their Iphone, such as participating in votes or polls at the venue, receive interactive advertisement, live statistics, team roster and schedule information, venue navigation (e.g., maps and other information about concessions, services, stores, etc., located near the seat bought by the user), live video of plays, top plays of the game or season, etc. All these materials are available from the ad provider 32 and content provider 34 and are preferably delivered through the ticket server 20.

The information collected from the users during the processes described above can be used for targeting advertising to user profiles, generating a viral score that may be used to predict whether a user will be joined by another user of his group, spending habits and patterns of the user during the event, etc.

The system can be configured to include several additional features, including providing users to trade or swap. Preferably any post sales transactions are also accompanied by a service fee. In one aspect, the service fee for a purchase or transaction (including swapping) is calculated based on a number of different parameters.

In one embodiment, incentives are provided for users to buy tickets to an event early. Users will be more inclined to buy such tickets if they know that their friends will be joining them. Swapping can be extended to adjacent groups of strangers. When one group is running short on tickets, a second group nearby is notified and seats from the second group are offered to the group with no seats. Closer friends within a group are encouraged to swap tickets so that they can be near each other. Such wraps can be implemented by submitting appropriate request to the system. Of course, the users must agree to such buy/sell, swap arrangements but they are encouraged to do so to collect more revenues.

In one embodiment, once a user reserves a block, he may be charged with a daily service fee for keeping it reserved until a friend buys the seat or the seat is reserved, or until the tickets are released. Thus, in one embodiment, the user may direct the server to release the tickets (step 416) even if the predetermined time has not expired.

In one embodiment, the ticket server 20 includes or is associated with a rating module 28. In FIG. 1, this rating module is shown as a separate element for the sake of clarity and receives information from the statistics module 26 as well as the ticket server 20 and the user database 22. The rating module monitors the activity of each user and generates a respective user indicative of how active he is, how effective he is at getting friends to join in events, and so on.

For example, for a given period of time (e.g., a year), the rating module 28 receives the number events has attended, the number of tickets he has bought, the number of times he started a seating group so that his friends can seat together, the number of times he bought blocks of seats for friends, the average number of seats sold to friends of a user as a result of his activities, and so on. Each of these activities can be assigned a score that may be an actual number, or a standard deviation based on the scores of the population of users being tracked by the rating module for service. For example, if a user reserves 9 blocks of seats during a year, and the average for the population is 7 with a standard deviation of 2, the user is assigned a score for this activity of 88 percentile. A total score can then be developed for the user, for example by adding together the scores from each activity. Of course, other criteria for generating a user score can be utilized as well.

The user scores from the rating module provide information that can be used to determine what various users, as well as groups of users (users who share common friends on a given media), class of users (e.g., users under the age of 30) like to watch or attend, how much they are willing to spend, etc. The advertisement servers and content servers can use this information when determining what content and ads are to be provided to the users during an event.

In addition, the ticket server can share this information with the ticket vendor, and the ticket vendor can then target the users having high scores with special ticket pricing during a certain event.

FIG. 4C shows a user is given the option of attending an event with a group of friends. The user is presented with an event (or otherwise selects an event)as described above and in step 460 indicates he selects an event. Next, in step 462 the user decides whether he wants to join an existing group (if any) or define a new group of friends as the possible attendees or participants of an activity of attending the event (e.g., attending a specified event at a designated venue and time such as seeing a concert at Central Park on Wednesday, November 6 at 8 pm). Once, the user decides that he wants to create a new group, the user next is given a choice of selecting a group of seats (or, alternatively a section of the venue where the event takes place—in this case in Central Park.) (step 464) The user then selects a seat (or several seats if he knows already that at least some of his friends or others are coming). This can be done manually or automatically. In one embodiment of the invention, the system itself may be set to allow only manual or only automatic seat selection.

For manual selection, the user selects his seat (or seats) from the selection of step 464 (step 466) and buys his ticket(s) through the ticket vendor (step 468). Next, he defines the new group of friends that he thinks may also be interested. and sets the privacy seating setting (step 470). This setting determined which friends of the user from the social network can see the event and can join the event as described above. In other words, during step 470, the user defines a group of his friends (either by using a hierarchical or relational information from the social network) who can participate in this activity. For example, in the social network, the user can designate various other members of the network as being friends, close friends, co-workers, relatives, etc. Then, when he sets up a group of friends for this activity by either designating specific friends from the social network by name, or he may designate the members of the group using hierarchical or relational rules of the social network. For example, he may designate his friends only, or relatives only, or friends and friends of friends, etc. Preferably, once the user selects the group is closed (e.g., no more members are added) unless the user initiating the activity decides to open the group. The process then ends (step 472).

For automatic selection (step 474) initially, the system determines what is the best seat for the user based on the event, the venue for the event, preferences by the user, etc. For example, the system may select the lowest rows within the group or section of selected seats, center seat. The user can then buy his ticket(s) (step 476) selected for him in step 474. He then select the members of the group who can attend the event as described for step 470 (step 478).

Thereafter, the members of the group defined in steps 470 or 478 can get notifications that they have been invited to join the group and participate in the respective activity.

Getting back to step 460, once a group is formed when a user decides that he wants to attend an event, or has been notified that there is an activity is going on for a group and he has been designated as a member of the group, then in step 462 he can decide to join the group or form his own group. If he wants to join the existing group then in step 480 he is informed as to whether the system has been set up to allow members to choose their own seat or not, with some indication of where the selected sears are. If the user is allowed to choose his seat, in step 482 he indicates that he wants to buy a seat (or several seats). In step 484 the system indicates to the user what seats are available and in steps 486 and 488 the user selects his seat(s) and pays for them. In step 490 the group listing maintained by the system is updated to indicate that the user has joined the group and, optionally, updates the listings to indicate where the user is seating. The process ends in step 492.

In step 480, if the system is using an automated process to assign seats, then the user is assigned seat(s) using this automated process in step 494 and adjusts the number of seats bought in step 496. For example, the system 10 may designate a seat for each user using predetermined rules (e;g., starting from the lowest row, the seat on the farthest right position is designated first and so on). Alternatively, no seats are assigned to any users until just prior to the event. Then seats are assigned to each user arbitrarily since the members of the group will decide who seats where when they get to the venue.

In another alternate embodiment similar to the one shown in FIG. 4C, a user may set up a group of members and the system 10 can go through the motions of assigning seats however no money is collected no tickets are actually sold until a predetermined number of members, e.g., 10 out of 30, indicate that they are ready to attend the event.

Numerous modifications may be made to this invention without departing from its scope as defined in the appended claims.

What is claimed is:

1. In a system for sharing event information about an event taking place at a venue including seats for viewing the event with friends belonging to a social network, the apparatus including a server coupled through a distributed computer network to the social network and to user devices associated with users who are members of the social network and a user data base coupled to said server and selectively storing information regarding users including relational information describing the relation between any two users as defined by the social network, a method for presenting sharing information about an event comprising the steps of:
presenting to users on the user devices event information about an upcoming event at the venue, said event information including a listing of users interested in the upcoming event;
receiving by the ticket server an indication from a user device indicating that a user is interested in the upcoming event as described by the event information; and
updating by said server the event information to add the user of the user device to said event information.

2. The method of claim 1 further comprising providing a posting by the server including said event information.

3. The method of claim 2 wherein said posting is an email.

4. The method of claim 2 wherein said posting is sent to the social network.

5. The method of claim 1 wherein said request includes a request for a ticket, said server being coupled to the ticket vendor for the event.

6. The method of claim 5 further comprising receiving an assignment of a seat for the user and including the assignment on the event information posted to the users.

7. The method of claim 5 further comprising receiving a second request for a seat from a second user and assigning a seat to the second user in a predetermined relationship with the seat of the first user.

8. A method of selling tickets for a predetermined event to a group of users on an event server, said users being members of a social network, the social network defining a relational association between the users, the method comprising the steps of:
posting event information by the event server to the users, the event information identifying un upcoming event and a listing of users associated with the upcoming event;
receiving by the event server a first request from a first device associated with a first user indicating a level of interest by the first user; and
in response to said request, modifying said event information by the event server to indicate the level of interest of the first user.

9. The method of claim 8 wherein the event server is coupled to a social network server servicing said social network, wherein said event information is posted to friends on said social network.

10. The method of claim 8 wherein said first request includes an indication that said first user wants to buy a ticket for the event.

11. The method of claim 10 wherein in response to said first request, a seat is assigned to said first user.

12. The method of claim 11 wherein in response to said first request, the event information is modified to indicate that the first user has bought a ticket.

13. The method of claim 12 wherein a second request is received from a second device indicating that the second user wants to buy another ticket, further comprising assigning by the event server of a seat in a predetermined relationship with the first seat.

14. The method of claim 13 wherein in response to said second request, presenting by said server to said second user via said second device seats available near said first seat and receiving a seat selection from said second device.

15. The method of claim 13 wherein in response to said second request, selecting a second seat for said second user by said event server.
